(19) United States
(12) Patent Application Publication
(10) Pub. No.: US 2025/0369527 A1
(43) Pub. Date: Dec. 4, 2025

(54) SPRING-LOADED RELIEF VALVES HAVING GUIDED SEATS

(71) Applicant: Emerson Automation Solutions Final Control US LP, Houston, TX (US)

(72) Inventors: Vishwa Kalyanasundaram, Stafford, TX (US); James Robert Thomas, El Campo, TX (US); Yuanyuan Chen, Shanghai (CN); Nalinkumar Jitendrabhai Rajput, Brookshire, TX (US); Yunxia Han, Shanghai (CN)

(21) Appl. No.: 19/222,775

(22) Filed: May 29, 2025

Related U.S. Application Data
(60) Provisional application No. 63/655,828, filed on Jun. 4, 2024.

(51) Int. Cl. F16K 17/04; F16K 17/06

(52) U.S. Cl. CPC F16K 17/0466; F16K 17/06; F16K 2200/304

(57) ABSTRACT

Spring-loaded relief valves having guided seats are disclosed. A disclosed example apparatus for use with a relief valve includes a valve body having a first aperture with a first diameter and a second aperture with a second diameter greater than the first diameter, the first and second apertures arranged along a longitudinal direction of the valve body, a spindle extending through the first and second apertures, the spindle including a first portion guided by a first wall of the first aperture, and a second portion adjacent the first portion, the second portion guided by a second wall of the second aperture, and a valve seat supported by the spindle at the second portion of the spindle.

### RELATED APPLICATION

This patent claims the benefit of U.S. Provisional Patent Application No. 63/655,828, which was filed on Jun. 4, 2024. U.S. Provisional Patent Application No. 63/655,828 is hereby incorporated herein by reference in its entirety. Priority to U.S. Provisional Patent Application No. 63/655,828 is hereby claimed.

### FIELD OF THE DISCLOSURE

This disclosure relates generally to process control devices, such as over pressure protection devices, and, more particularly, to spring-loaded relief valves having guided seats.

### BACKGROUND

Spring-operated pressure relief valves are used extensively in systems and vessels for over pressure protection. The operation of a spring-operated valve involves compressing a spring at a predetermined amount to control an opening point or a set pressure of a valve seat via a closing force. When the force exerted by the fluid onto the seat is equivalent to the closing force of the spring, the valve begins to open. An additional increase in fluid pressure can cause further opening of the valve. Conversely, a decrease in fluid pressure below the set pressure leads to closure of the valve. The difference between the closure pressure and set pressure is referred to as blowdown and almost all pressure relief valves (e.g., direct spring and pilot operated relief valves) have adjustable blowdown capability.

### SUMMARY

A disclosed example apparatus for use with a relief valve includes a valve body having a first aperture with a first diameter and a second aperture with a second diameter greater than the first diameter, the first and second apertures arranged along a longitudinal direction of the valve body, a spindle extending through the first and second apertures, the spindle including a first portion guided by a first wall of the first aperture, and a second portion adjacent the first portion, the second portion guided by a second wall of the second aperture, and a valve seat supported by the spindle at the second portion of the spindle.

An example relief valve includes a nozzle defining a channel with a first diameter, and a body defining a first opening to receive a spindle, the first opening having a first stepped profile to receive a second stepped profile of the spindle, the body defining a second opening to surround a distal portion of the nozzle, the second opening having a second diameter, wherein a ratio of the second diameter to the first diameter is in a range between approximately 8 and 12

An example valve seat for use with a relief valve includes a base portion having a first diameter, the base portion to be at least partially disposed in a spindle, and an interface portion, the interface portion having a second diameter greater than the first diameter, the interface portion having a flared head to contact a nozzle of the relief valve.

An example method of assembling or retrofitting a relief valve includes providing a spindle with a first stepped profile to a second stepped profile of a valve body of the relief valve, and providing a valve seat to the spindle, the valve seat including at least one of a drafted surface or a flared head.

### BRIEF DESCRIPTION OF THE DRAWINGS

FIG. 1 illustrates an example relief valve in accordance with teachings of this disclosure.

FIG. 2 is a cross-sectional view of the example relief valve shown in FIG. 1.

FIGS. 3A and 3B are cross-sectional views of open and closed states, respectively, of the example relief valve of FIGS. 1 and 2.

FIGS. 4A and 4B are detailed cross-sectional views of a portion of the example relief valve of FIGS. 1-3B.

FIGS. 5A-5C depict example body clearance openings that can be implemented in examples disclosed herein.

FIGS. 6A-6F depict example seat arrangements that can be implemented in examples disclosed herein.

FIGS. 7A-7C depict example body outlet openings that can be implemented in examples disclosed herein.

FIG. 8 is a flowchart representative of an example method assembly and/or retrofit examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Spring-loaded relief valves having guided seats are disclosed. Spring-compressed pressure relief valves can be subject to significant forces depending on a pressure of fluid being provided thereto. In particular, the pressure relief valves are utilized for over pressure protection. A pressure relief valve operates with a valve seat that is loaded by a spring such that pressure of fluid provided at an inlet of the relief valve can overcome a force of the spring, thereby enabling the fluid to move to the outlet of the pressure relief valve.

Examples disclosed herein can improve operation of pressure relief valves. Examples disclosed herein can reduce excess and/or unintended movement of a valve seat, thereby increasing reliability and service life thereof. Examples disclosed herein can mitigate and/or reduce simmer, which is an audible or visible escape of fluid between a disc and a valve seat that occurs when the valve opens slightly. Examples disclosed herein can be implemented in a cost-effective manner. Examples disclosed herein can be advantageously used in relatively high pressure applications (e.g., pressures of 6 kpsig and higher). Examples disclosed herein can reduce a distance between a seating plane of a valve body and a guiding plane of a spindle carrying the valve seat to mitigate rotation and/or movement of the spindle and the valve seat. Examples disclosed herein reduce the amount that at least one surface of the aforementioned valve seat is exposed to a relatively high pressure and/or high flow (e.g., a high side flow). Examples disclosed herein increase seat integrity as well as creep resistance.

Some examples disclosed herein utilize multiple guiding surfaces of a valve housing/body of a relief valve. The guiding surfaces define a stepped profile to receive another stepped profile of a spindle that supports a valve seat, thereby improving control of the relief valve. Examples disclosed herein utilize multiple geometric features of the body and the spindle to improve flow control and reduce wear of the relief valve. Some examples disclosed herein utilize an increased clearance of an opening of the body, which can be referred to as a body bowl, to a portion of a nozzle of the relief valve to reduce uneven and/or asymmetric loading of the spindle and/or the valve seat. In some such examples, a ratio of a first diameter of the opening to a second diameter of an internal channel of the nozzle is in a range of approximately 5 to 15 (e.g., in a range of 8 to 12). In some examples, the aforementioned opening resembles a shape of a cylinder to facilitate manufacturing, for example.

In some examples, the valve seat includes a flared end/head at an interface portion thereof. Additionally or alternatively, the valve seat includes a drafted edge, wall and/or a side. In some examples, the spindle includes a relief (e.g., a relief cut) proximate a transition of the stepped profile thereof. In some examples, the stepped profile of the body includes a chamfer or a rounded edge. In some examples, the spindle and the body have a clearance fit therebetween. In some examples, the spindle includes a ramped surface at a distal end. In some examples, the spindle includes a lip to support lateral sides of the seat.

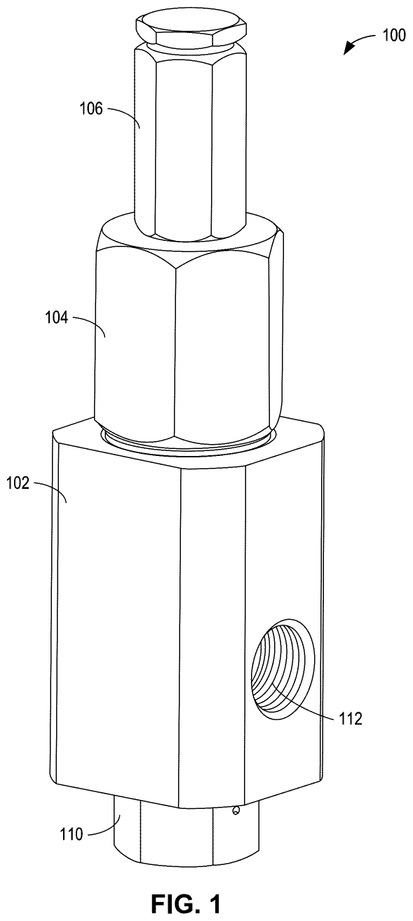

FIG. 1 illustrates an example relief valve (e.g., a pressure relief valve, a safety relief valve, a fixed blowdown valve, etc.) 100 in accordance with teachings of this disclosure. The relief valve 100 of the illustrated example includes a body (e.g., valve body) 102, a bonnet 104 and an adjuster 106. In this example, the relief valve 100 includes an inlet (e.g., an inlet opening) 110 and an outlet (e.g., an outlet opening) 112. In this particular example, the relief valve 100 is implemented as a pressure relief valve that is utilized with a fluid, such as a gas, for example.

In operation, a pressure of fluid at the inlet 110 exceeding a threshold pressure causes the valve 100 to open. As a result, fluid can flow from the inlet 110 to the outlet 112. According to examples disclosed herein, an increased amount of pressure at the inlet 110 can cause an increased amount of fluid to flow between the inlet 110 and the outlet.

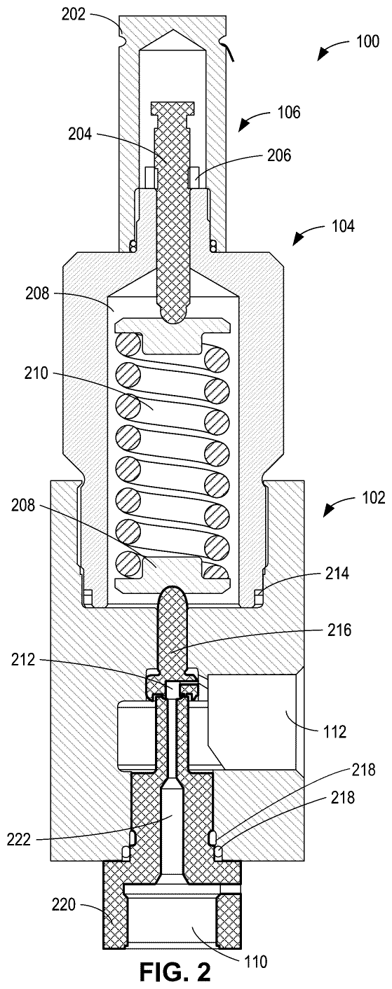

FIG. 2 is a cross-sectional view of the example relief valve shown 100 in FIG. 1. In the illustrated example of FIG. 2, the example valve 100 includes the aforementioned adjuster 106 which, in turn, includes a cap 202 and a pressure adjusting screw 204 that is threadably coupled to a lock nut 206. Further, the example relief valve 100 includes washers (e.g., spring washers, upper and lower spring washers, etc.) 208, a spring (e.g., a coil, a spring element, etc.) 210, a seat 212, a seal 214, a spindle (e.g., a seat support) 216, a seal 218 and a nozzle (e.g., a nozzle assembly) 220.

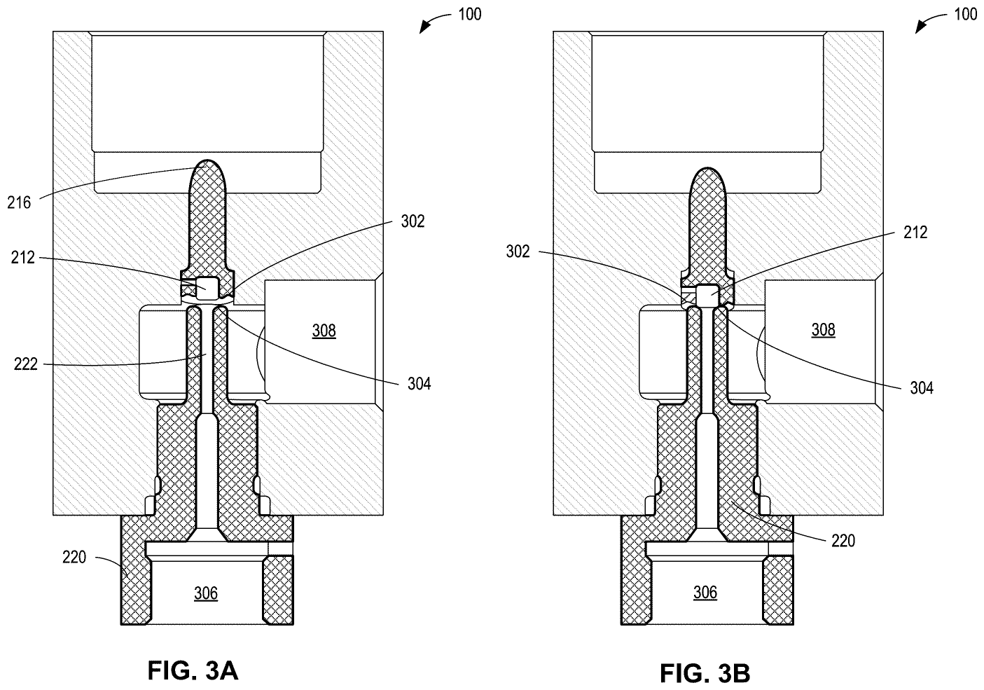

According to examples disclosed herein, to open/close the valve 100, fluid, such as a gas, flows into a channel (e.g., an internal channel) 222 and toward the seat 212, thereby causing the seat 212 to move. Movement of the seat 212 adjusts an amount of fluid flowing through the valve 100. In particular, when a pressure of the fluid exceeds a force of the spring 210 exerted onto the lower washer 208 and, in turn, the upward movement (in the view of FIG. 2) of the spindle 216, which is supported by the body 102) enables fluid to flow through the valve between the inlet 110 and the outlet 112. In other words, the pressure of the fluid exceeding a threshold (e.g., a pressure threshold, a spring force threshold, etc.) enables fluid to move from the inlet 110 to the outlet 112. According to some examples disclosed herein, the force of the spring 210 can be adjusted via the pressure adjusting screw 204 to vary a pressure (e.g., a set pressure) at which the valve 100 opens/closes. As will be described in connection with FIGS. 3A-8, examples disclosed herein can enable improved operational life of valves. Examples disclosed herein can improve flow control (e.g., reduce simmer) and improve operational life of valves. Examples disclosed herein can also improve and/or reduce wear of valve seats, thereby improving an overall operational life thereof. Examples disclosed herein can be assembled to newly produced valves or valves operating in the field (e.g., in a retrofit process).

FIGS. 3A and 3B are cross-sectional views of open and closed states, respectively, of the example relief valve of FIGS. 1 and 2. Turning to FIG. 3A, the valve 100 is shown in an open state. In particular, the seat 212 is shown displaced away from the nozzle 220 based on a pressure of fluid moving through the channel 222 such that a surface 302 of the spindle 216 is separated from a surface 304 of the nozzle 220. In turn, the displacement of the seat 212 against a counteracting force of the spring 210 enables fluid to flow through the valve 100 between a chamber 306 and a chamber 308.

FIG. 3B, in contrast to the view shown in FIG. 3A, depicts the example relief valve 100 in a closed state with the surface 302 contacting the surface 304. In this example, the seat 212 contacts the nozzle 220 based on a pressure of the fluid in the channel 222 not exceeding a spring force of the spring 210 shown in FIG. 2. Accordingly, the seat 212 contacting the nozzle 220 prevents fluid from flowing through the valve 100 between the chamber 306 and the chamber 308.

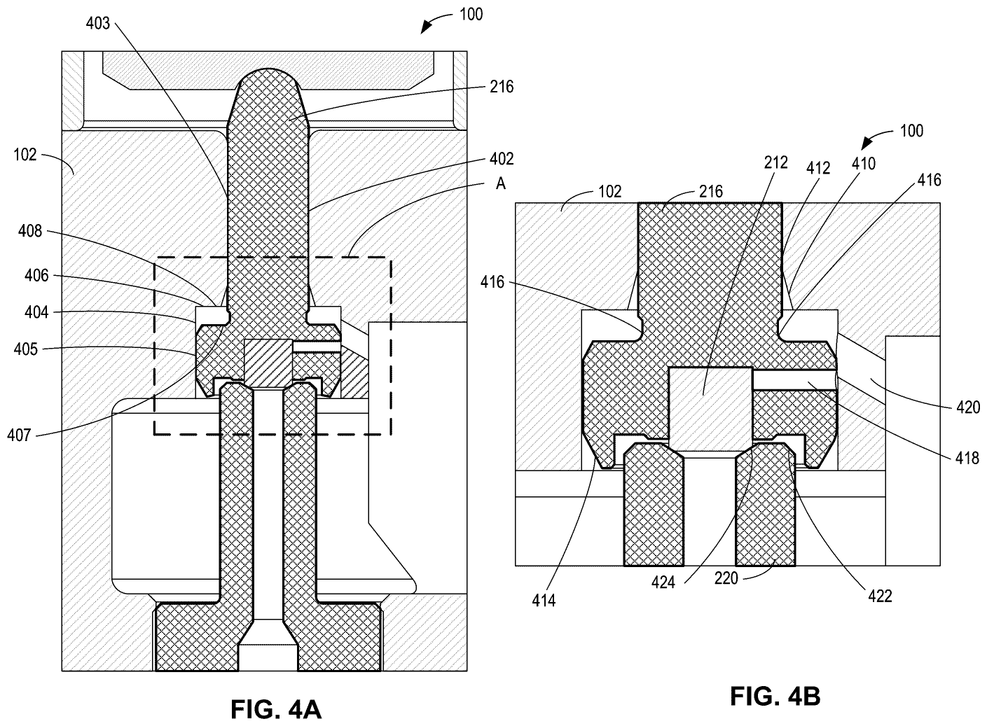

FIGS. 4A and 4B are detailed cross-sectional views of a portion of the example relief valve 100 of FIGS. 1-3B. Turning to FIG. 4A, the spindle 216 is shown supported and/or carried by the body 102. In this example, the body 102 advantageously constrains and supports the spindle 216 with a guiding surface 402 as well as a guiding surface 404, together which define a stepped profile. In this example, an internal opening 406 that is defined by the guiding surfaces 402, 404, captures and/or restrains surfaces 403, 405, respectively, of the spindle 216, thereby preventing excess motion of the spindle 216, which can be translational or rotational. In this example, the guiding surface 402 corresponds to a first portion of the spindle 216 having a smaller cross-sectional area/diameter while the guiding surface 404 corresponds to a second portion of the spindle 216 having a larger cross-sectional area/diameter. In other words, the body 102 shrouds the spindle 216 with the guiding surfaces 402, 404. As mentioned above, the guiding surfaces 402, 404 define a first stepped profile of the body to interface and/or guide a second stepped profile of the spindle 216 defined by the surfaces 403, 405. Further, a clearance between a surface 407 of the spindle 216 and a surface 408 of the body 102 defines a range of movement of the spindle 216 with respect to the body 102. In this example, each of the guiding surfaces 402, 404 defines a clearance interface (e.g., a clearance fit) to surfaces 403, 405 of the spindle 216.

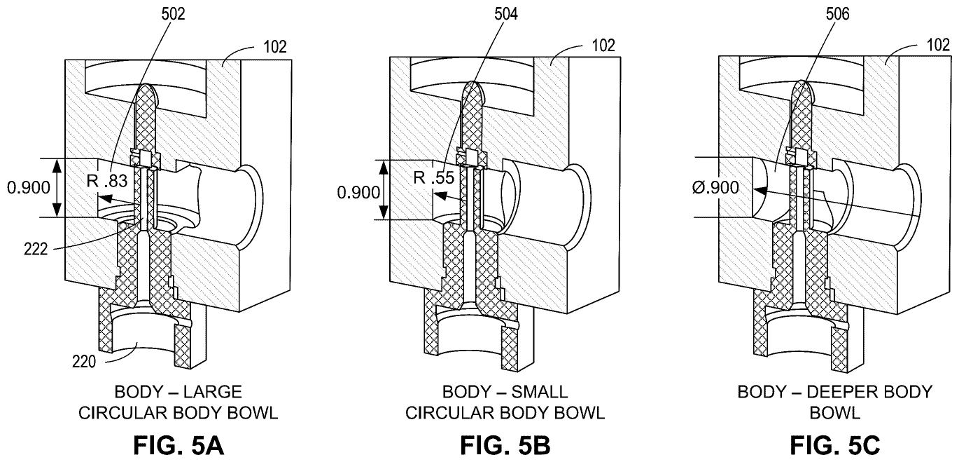

FIG. 4B is a detail of a portion A shown in FIG. 4A. In the illustrated example of FIG. 4B, the seat 212 is shown supported and positioned by the spindle 216. According to examples disclosed herein, the body 102 includes a chamfer (e.g., a ramped surface/edge) 410 to control forces imparted to the spindle 216 and/or control displacement of the spindle 216. According to some examples disclosed herein, the chamfer 410 is approximately 70 to 80 degrees (e.g., 75 degrees) from horizontal (in the view of FIG. 4B). In some examples, the chamfer 410 includes a round 412 on at least one edge (e.g., an upper edge of the chamfer 410 in the view of FIG. 5B).

In this example, the spindle 216 includes a chamfer (e.g., ramped surface/edge) 414 to reduce stresses induced therein. Additionally or alternatively, the example spindle 216 includes a relief (e.g., an annular relief, an annular groove, an indent etc.) 416 to control and/or reduce stresses experienced by the spindle 216 and/or the seat 212. For example, the relief 416 can enable the spindle to deform (e.g., elastically deform) without significantly impacting guiding surface interfaces. In some examples a channel 418 is implemented to facilitate manufacturing of the valve 100 such that the channel 418 prevents the seat 212 from being removed from the valve 100. Further, an example relief channel 420 is implemented to relieve pressure generated at the surface 407 of the spindle 216 shown in FIG. 4A. According to some examples disclosed herein, the nozzle 220 includes a chamfer 422 (or a round) for an advantageous pressure distribution and/or a chamfer 424 for increased sealing contact to the seat 212. In some examples, the seat 212 includes and/or is at least partially composed of Arlon® 3000XT produced by Greene Tweed or Torlon® produced by Solvay. However, any other appropriate material can be implemented instead.

FIGS. 5A-5C depict example body clearance openings that can be implemented in examples disclosed herein. In the illustrated example of FIG. 5A, a circular body bowl (e.g., an opening, an aperture, a body cavity, etc.) 502 is shown defined in the body 102. In this example, a relatively large size of the circular body bowl 502 enables forces to be generally equalized along a lateral (side to side) direction shown in FIG. 5A. According to some examples disclosed herein, a ratio of a diameter of the circular body bowl 502 to a diameter of the inner channel 222 of the nozzle 220 is in a range of approximately 8 to 12 (e.g., 10). In some examples, the circular body bowl 502 has a longitudinal length of approximately 0.90 inches (in) and a radius of approximately 0.83 in. However, any other appropriate dimensions/ratios can be implemented instead.

FIG. 5B depicts a relatively small circular body bowl 504 defined the body 102. In particular, the body bowl 504 has a reduced lateral clearance to the body bowl 502 of FIG. 5A. In some examples, the body bowl 504 has a length of 0.90 in and a radius of 0.55 in.

Turning to FIG. 5C, a deep body bowl 506 is shown defined in the body 102. In contrast to the example body bowl 502 of FIG. 5A and the example body bowl 504 of FIG. 5B, the body bowl 506 is generally shaped as a cylindrical cut in a direction orthogonal to those shown in FIGS. 5A and 5B. However, any other appropriate cut and/or internal aperture shape can be implemented instead. In some examples, the deep body bowl 506 has cylindrical shape with a diameter of 0.90 in.

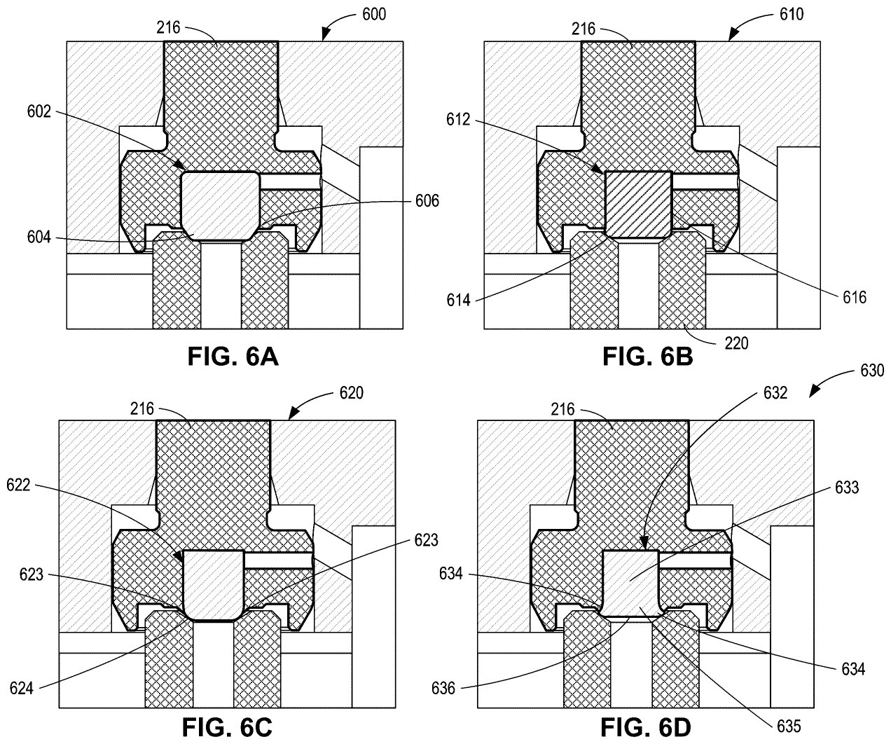

FIGS. 6A-6E depict example seat arrangements 600, 610, 620, 630, 640, 650, respectively, that can be implemented in examples disclosed herein. FIG. 6A is a cross-sectional view of the example seat arrangement 600 having a seat 602. In this example, the seat 602 is supported by the spindle 216 and includes a chamfer (e.g., a ramped edge/surface) 604 at a distal end thereof. In some examples, the chamfer 604 can be angled in a range from approximately 45 to 60 degrees from horizontal (in the view of FIG. 6A). The chamfer 604 may also include a rounded edge and/or surface. In some examples, the nozzle 220 has a chamfer 604 to contact the seat 602. In some examples, the spindle 216 includes a secondary seat 606 to provide metal-to-metal contact. In some such examples, the secondary seat 606 can also enhance the capacity of the valve 100 by redirecting flow to the side (as shown in FIG. 6A).

FIG. 6B is a cross-sectional view of the example seat arrangement 610 corresponding to a seat 612 supported by the spindle 216. In this example, the seat 612 has a smaller diameter than that of the seat 602 of FIG. 6A. The example seat 612 includes a round 614 at a distal end thereof. In turn, the chamfer 614 corresponds to relatively horizontal walls 616.

FIG. 6C is a cross-sectional view of the example seat arrangement 620 with a seat 622. In the illustrated example of FIG. 6C and in contrast to the example of FIG. 6B, the spindle 216 includes a lip 623 that extends to and/or proximate corners 624 of the seat 622. Accordingly, the lip 623 can prevent unwanted and/or excessive displacement of the seat 622. In some examples, multiple lips, surface levels and/or stepped profiles are utilized.

FIG. 6D is a cross-sectional view of the aforementioned seat arrangement 630 having a seat 632. The example seat 632 includes a base portion (e.g., a main portion) 633 and an interface portion (e.g., a sealing portion) 635. In the illustrated example of FIG. 6D, the seat 632 includes flared edges 634 at a sealing surface end (e.g., a distal end) 636 of the seat 632. The example flared edges 634 define a flared head or portion (e.g., a flared end) for improved flow control. In some examples, the flared head and/or the interface portion 635 can define an interference fit with the spindle 216.

FIG. 6E is a cross-sectional view of the example seat arrangement 640. In this example, the seat arrangement 640 includes a seat 642 having a drafted wall 644. In particular, the drafted wall 644 converges in a direction opposite from the nozzle 220 (not shown). In some examples, the seat 642 includes rounded edges 646.

Turning to FIG. 6F, the seating arrangement 650 with an example seat 652 is shown. In this example, the seat 652 includes a flared surface (e.g., a flared distal end/head) 654 with a corresponding rounded edge 656. Further, in some examples, the spindle 216 includes a drafted wall 658 that extends from the flared end 654.

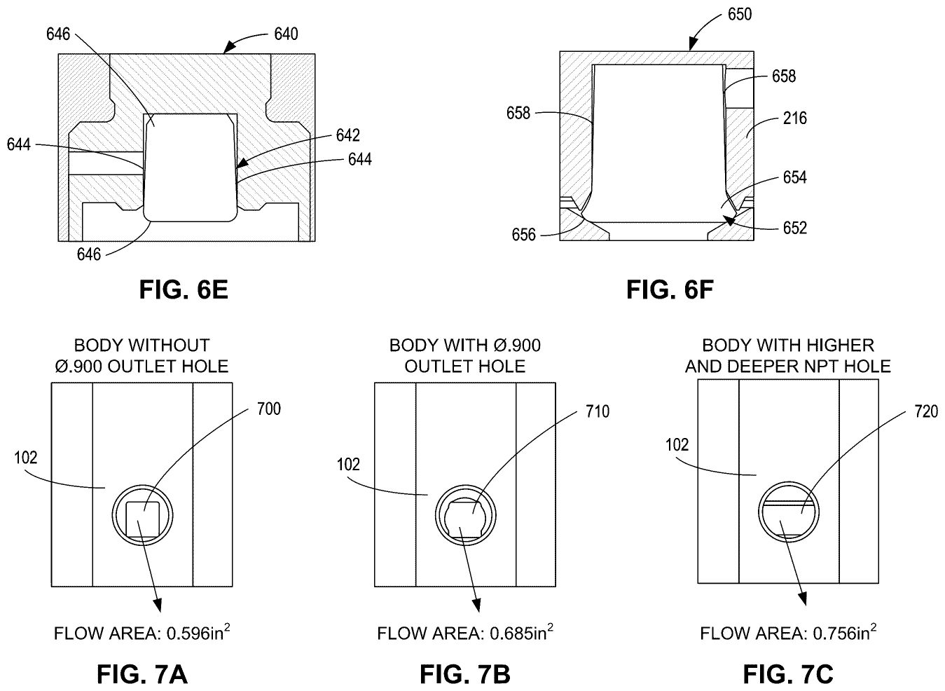

FIGS. 7A-7C depict example body outlet openings that can be implemented in examples disclosed herein. The examples of FIGS. 7A-7C correspond to the example of FIGS. 5A-5C, respectively, and indicate that outlet openings can be adjusted with increasing nozzle clearance in a valve body according to examples disclosed herein to advantageously adjust for nozzle clearances. In particular, FIG. 7A includes an opening 700 of the body 102 with a flow area of approximately 0.596 inches squared (in²), FIG. 7B represents an opening 710 of the body 102 with a flow area of approximately 0.685 in², and FIG. 7C represents an opening 720 of the body 102 with a flow area of approximately 0.756 in². However, any other appropriate flow area can be implemented instead.

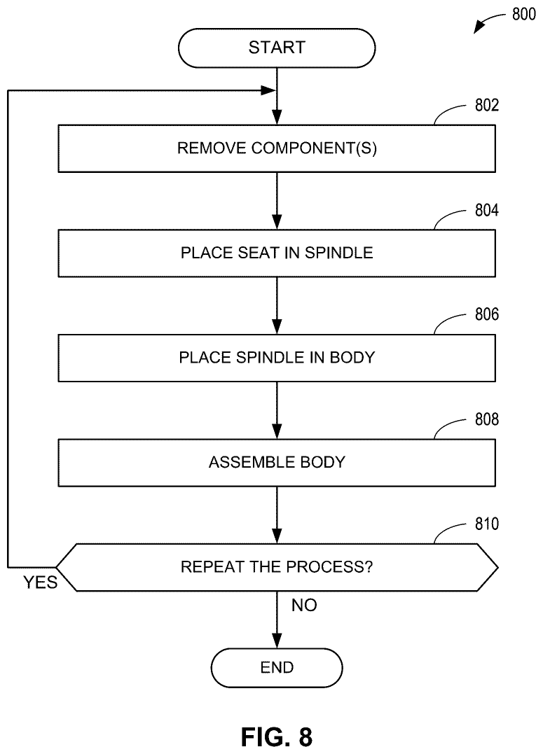

FIG. 8 is a flowchart representative of an example method 800 that can be implemented for assembly, service and/or to retrofit existing relief valves with examples disclosed herein. The example method 800 begins as a relief valve is to be assembled and/or retrofitted with examples disclosed herein.

At block 802, in some examples, at least one component is removed from the relief valve (e.g., in a retrofit or an upgrade process). For example, a valve body and/or valve body may be removed from a valve that is being utilized in the field or other operational environment.

At block 804, a seat is placed in and/or assembled to a spindle. For example, the seat may have a flared end/head/portion for contact with a nozzle. In some examples, a retainer or other component is utilized to couple the spindle to the seat.

At block 806, the spindle is placed in the valve body. In this example, the spindle is assembled to the valve body with the seat coupled thereto. In this example, the spindle is movably coupled to the valve body via a spring.

At block 808, in some examples, the valve body is assembled to a valve. In other examples, the valve body is already assembled to the valve as the spindle is assembled thereto.

At block 810, it is determined whether to repeat the process. If the process is to be repeated, control of the process returns to block 802. Otherwise, the process ends. This determination may be based on whether additional valves are to be assembled, serviced and/or retrofitted with examples disclosed herein.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to enable improved valve control and reliability are disclosed herein. Further examples and combinations thereof include the following:

Example 1 includes an apparatus for use with a relief valve, the apparatus comprising a valve body having a first aperture with a first diameter and a second aperture with a second diameter greater than the first diameter, the first and second apertures arranged along a longitudinal direction of the valve body, a spindle extending through the first and second apertures, the spindle including a first portion guided by a first wall of the first aperture, and a second portion adjacent the first portion, the second portion guided by a second wall of the second aperture, and a valve seat supported by the spindle at the second portion of the spindle.

Example 2 includes the apparatus as defined in example 1, further including a nozzle with an internal channel that is directed toward the valve seat, the internal channel having a first diameter.

Example 3 includes the apparatus as defined in any one or more of examples 1 or 2, wherein the body includes a body bowl adjacent a distal end of the spindle, the body bowl having a second diameter, wherein a ratio of the second diameter to the first diameter is in a range from approximately 8 to 12.

Example 4 includes the apparatus as defined in any one or more of examples 1 to 3, wherein the body includes a chamfer between the first aperture and the second aperture.

Example 5 includes the apparatus as defined in any one or more of examples 1 to 4, wherein the spindle includes a relief between the first and second portions.

Example 6 includes the apparatus as defined in any one or more of examples 1 to 5, wherein the valve seat includes a flared portion at a distal end of the spindle.

Example 7 includes the apparatus as defined in any one or more of examples 1 to 6, further including a spring operatively coupled to the spindle to counteract pressure of fluid flowing toward the valve seat.

Example 8 includes a relief valve comprising a nozzle defining a channel with a first diameter, and a body defining a first opening to receive a spindle, the first opening having a first stepped profile to receive a second stepped profile of the spindle, the body defining a second opening to surround a distal portion of the nozzle, the second opening having a second diameter, wherein a ratio of the second diameter to the first diameter is in a range between approximately 8 to 12.

Example 9 includes the relief valve as defined in example 8, wherein the first stepped profile includes a chamfer between first and second chambers having respective different diameters from one another.

Example 10 includes the relief valve as defined in any one or more of examples 8 or 9, further including the spindle, the spindle supporting a valve seat with a drafted surface.

Example 11 includes the relief valve as defined in any one or more of examples 8 to 10, wherein the valve seat includes a flared head.

Example 12 includes the relief valve as defined in any one or more of examples 8 to 11, wherein the spindle includes a lip to extend to proximate a distal end of the valve seat.

Example 13 includes the relief valve as defined in any one or more of examples 8 to 12, wherein the body and the spindle define a clearance interface therebetween.

Example 14 includes the relief valve as defined in any one or more of examples 8 to 13, wherein the second opening includes a cylindrical aperture.

Example 15 includes a valve seat for use with a relief valve, the valve seat comprising a base portion having a first width, the base portion to be at least partially disposed in a spindle, and an interface portion, the interface portion having a second width greater than the first width, the interface portion having a flared head to contact a nozzle of the relief valve.

Example 16 includes the valve seat as defined in example 15, further including a rounded edge at a distal end of the interface portion.

Example 17 includes the valve seat as defined in any one or more of examples 15 or 16, wherein the base portion and the interface portion defined a drafted outer surface therebetween.

Example 18 includes the valve seat as defined in any one or more of examples 15 to 17, wherein the interface portion includes a flared head.

Example 19 includes a method of assembling or retrofitting a relief valve, the method comprising providing a spindle with a first stepped profile to a second stepped profile of a valve body of the relief valve, and providing a valve seat to the spindle, the valve seat including at least one of a drafted surface or a flared head.

Example 20 includes the method as defined in example 19, wherein the valve body is a first valve body, and further including removing a second valve body from the relief valve prior to placing the first valve body in the relief valve.

From the foregoing, it will be appreciated that example systems, apparatus, articles of manufacture, and methods have been disclosed that enable accurate flow control of valves. Examples disclosed herein can also mitigate and/or reduce undesirable flow behavior of valves. Examples disclosed herein can be implemented in a cost effective manner and can also enable increased reliability of valves.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for use with a relief valve, the apparatus comprising:
a valve body having a first aperture with a first diameter and a second aperture with a second diameter greater than the first diameter, the first and second apertures arranged along a longitudinal direction of the valve body;
a spindle extending through the first and second apertures, the spindle including:
a first portion guided by a first wall of the first aperture, and
a second portion adjacent the first portion, the second portion guided by a second wall of the second aperture; and
a valve seat supported by the spindle at the second portion of the spindle.

2. The apparatus as defined in claim 1, further including a nozzle with an internal channel that is directed toward the valve seat, the internal channel having a first diameter.

3. The apparatus as defined in claim 2, wherein the body includes a body cavity adjacent a distal end of the spindle, the body cavity having a second diameter, wherein a ratio of the second diameter to the first diameter is in a range from approximately 8 to 12.

4. The apparatus as defined in claim 1, wherein the body includes a chamfer between the first aperture and the second aperture.

5. The apparatus as defined in claim 1, wherein the spindle includes a relief between the first and second portions.

6. The apparatus as defined in claim 1, wherein the valve seat includes a flared portion at a distal end of the spindle.

7. The apparatus as defined in claim 1, further including a spring operatively coupled to the spindle to counteract pressure of fluid flowing toward the valve seat.

8. A relief valve comprising:
a nozzle defining a channel with a first diameter; and
a body defining a first opening to receive a spindle, the first opening having a first stepped profile to receive a second stepped profile of the spindle, the body defining a second opening to surround a distal portion of the nozzle, the second opening having a second diameter, wherein a ratio of the second diameter to the first diameter is in a range between approximately 8 to 12.

9. The relief valve as defined in claim 8, wherein the first stepped profile includes a chamfer between first and second chambers having different diameters from one another.

10. The relief valve as defined in claim 8, further including the spindle, the spindle supporting a valve seat with a drafted surface.

11. The relief valve as defined in claim 10, wherein the valve seat includes a flared head.

12. The relief valve as defined in claim 10, wherein the spindle includes a lip to extend to proximate a distal end of the valve seat.

13. The relief valve as defined in claim 8, wherein the body and the spindle define a clearance interface therebetween.

14. The relief valve as defined in claim 8, wherein the second opening includes a cylindrical aperture.

15. A valve seat for use with a relief valve, the valve seat comprising:
a base portion having a first diameter, the base portion to be at least partially disposed in a spindle; and
an interface portion, the interface portion having a second diameter greater than the first diameter, the interface portion having a flared head to contact a nozzle of the relief valve.

16. The valve seat as defined in claim 15, further including a rounded edge at a distal end of the interface portion.

17. The valve seat as defined in claim 15, wherein the base portion and the interface portion defined a drafted outer surface therebetween.

18. The valve seat as defined in claim 15, wherein the base portion includes drafted walls.

19. A method of assembling or retrofitting a relief valve, the method comprising:
providing a spindle with a first stepped profile to a second stepped profile of a valve body of the relief valve; and
providing a valve seat to the spindle, the valve seat including at least one of a drafted surface or a flared head.

20. The method as defined in claim 19, wherein the valve body is a first valve body, and further including removing a second valve body from the relief valve prior to placing the first valve body in the relief valve.
